(19) United States
(12) Patent Application Publication
(10) Pub. No.: US 2004/0056157 A1
(43) Pub. Date: Mar. 25, 2004

(54) Latticework trunking

(75) Inventor: Pierre-Stephane Dufourg, Paris (FR)

Correspondence Address: PIPER RUDNICK, P. O. BOX 64807, CHICAGO, IL, 60664-0807, US

(73) Assignee: SOCIETE DE CONSTRUCTIONS ELECTRIQUES DE LA SEINE (CES).

(21) Appl. No.: 10/606,040

(22) Filed: Jun. 25, 2003

(30) Foreign Application Priority Data
Jun. 26, 2002 (FR) FR 02 07929

(51) Int. Cl. F16L 3/22

(52) U.S. Cl. 248/68.1; 211/26; 174/48

(57) ABSTRACT

Trunking comprising a bottom and two lateral flanges, consisting of rigid lengthwise wires and rigid crosswise wires, the crosswise wires being fixed to the lengthwise wires on the inside of the trunking. The lengthwise wires belonging to the bottom of the trunking each consist of a succession of longitudinal portions connected by bends protruding away from the interior volume of the trunking, the bends of the lengthwise wires being designed to accommodate the crosswise wires and being sized so that the crosswise wires and the longitudinal portions of the lengthwise wires lie at the same level.

### FIELD OF THE INVENTION

The present invention relates to latticework trunking.

More specifically, the invention relates to trunking running longitudinally in a first direction and comprising at least one substantially U-shaped section that has a bottom and two lateral flanges, said trunking delimiting an interior volume designed to accommodate flexible or semi-rigid pipes or lines (cables, hoses or the like) running longitudinally in the first direction, the said trunking comprising rigid lengthwise wires running substantially parallel to the first direction and rigid crosswise wires running substantially at right angles to the first direction, the crosswise wires being fixed to the lengthwise wires toward the interior volume of the trunking, and each crosswise wire comprising a base portion belonging to the bottom of the trunking and two lateral branches belonging respectively to each lateral flange of the trunking.

### BACKGROUND OF THE INVENTION

Document U.S. Pat. No. 5,062,605 describes an example of latticework trunking of this type.

This known latticework trunking has the advantage that the crosswise wires, that at least partially take the weight of the pipes or lines laid in the trunking, are arranged on top of the lengthwise wires and are therefore effectively supported by the latter, the lengthwise wires also being supported by brackets, yokes or other support members.

Known latticework trunking of this type does, however, have the disadvantage that the pipes or lines contained in the trunking experience deformation where they cross the crosswise wires, under the effect of their self-weight and/or under the effect of the pressure exerted by clamps that secure the said pipes or lines to the latticework trunking.

These deformations of the pipes or lines contained in the latticework trunking are detrimental both to the life and to the performance of these pipes or lines and to optimal use of the space available inside the latticework trunking.

### SUMMARY OF THE INVENTION

It is a particular objective of the present invention to alleviate this disadvantage.

To this end, according to the invention, at least the lengthwise wires belonging to the bottom of the trunking each comprise a succession of longitudinal portions connected by bends protruding away from the interior volume of the trunking, the bends of the lengthwise wires being designed to accommodate the base portions of the crosswise wires and being sized so that said base portions of the crosswise wires and the longitudinal portions of the lengthwise wires lie at substantially the same level.

By virtue of these arrangements, the pipes or lines arranged in the latticework trunking can rest more or less flat on the bottom of the said latticework trunking so that the local deformation experienced by the said pipes or lines when they are resting in the latticework trunking are markedly reduced.

Furthermore, for the same trunking capacity, the invention allows a heightwise saving equal to the diameter of the crosswise wires, because it is possible to have the lengthwise wires supported by support members located between the crosswise wires. By way of example, with crosswise wire diameters of between 4 and 5 mm and flange heights of between 35 and 50 mm, it thus becomes possible to make a height saving of between 8 and 15% by comparison with the latticework trunking of the prior art.

Finally, when the bottom of the trunking rests against a wall or on the ground, the securing of the pipes or lines by clamps, which are generally passed around the lengthwise wires, becomes easier because of the space left by the bends between, on the one hand, the ground or the wall and, on the other hand, the longitudinal portions of the lengthwise wires.

In various embodiments of the invention, recourse may further be had to one and/or other of the following arrangements:

the longitudinal portions of the lengthwise wires are straight and parallel to the first direction;

the base portions of the crosswise wires and the longitudinal portions of the lengthwise wires are arranged in substantially the same plane;

the bends of the lengthwise wires each have a width, measured in the first direction, that substantially corresponds to the thickness of a crosswise wire;

the bends of the lengthwise wires each have a width, measured in the first direction, that is greater than the thickness of a crosswise wire;

the bends in the lengthwise wires each have a flat bottom.

### BRIEF DESCRIPTION OF THE DRAWINGS

Other features and advantages of the invention will become apparent in the course of the following detailed description of two of these embodiments, given by way of non-limiting examples, with reference to the attached drawings.

In the drawings:

FIG. 1 is a perspective view of part of some latticework trunking according to one embodiment of the invention,

FIG. 2 is a view in longitudinal section of the trunking of FIG. 1,

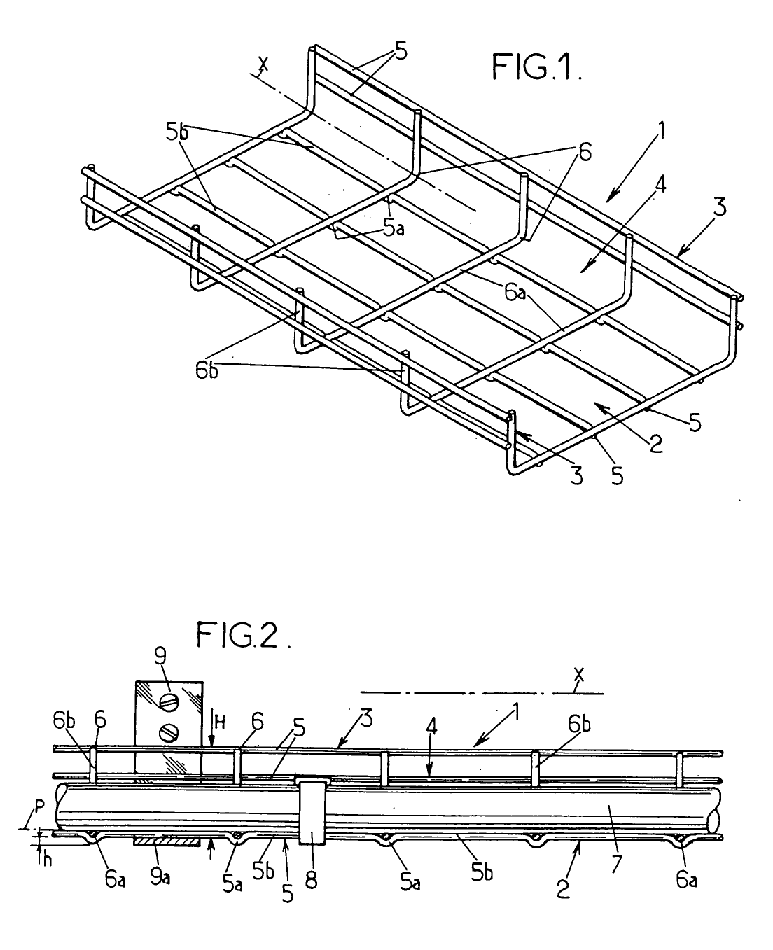

and FIG. 3 is a view similar to FIG. 1, in the case of a second embodiment of the invention.

### MORE DETAILED DESCRIPTION

In the various figures, the same references denote elements that are identical or similar.

As depicted in FIG. 1, the invention relates to trunking 1 more particularly intended to be used as a conduit for cables, but which could support any other flexible or semi-rigid pipe or line (hoses or the like).

The trunking 1 runs longitudinally in a direction X which, in the example depicted, is a straight, generally horizontal direction, but the direction X could, as appropriate, be curved and/or not horizontal.

In the example depicted, the trunking 1 has a roughly U-shaped cross section, with a bottom 2 and two lateral flanges 3. More generally, the trunking 1 could have such a U-shaped cross section supplemented by other walls, for example a lid wall (not depicted) partially covering the bottom 2 and extending the free end of at least one of the lateral flanges 3.

The bottom 2 and the flanges 3 of the trunking 1 delimit an interior volume 4 designed to accommodate the cables or other pipes or lines mentioned above, running longitudinally in the direction X.

The trunking 1 consists of a latticework of rigid wires of circular or non-circular cross section, generally made of metal, that are joined together by any known means, particularly by welding.

These rigid wires comprise:

rigid lengthwise wires 5 which run more or less in the longitudinal direction X (the lengthwise wires may be strictly parallel to the direction X or, alternatively, these lengthwise wires may, for example, be wavy as they run in the general direction X),

and rigid crosswise wires 6 which run roughly at right angles to the longitudinal direction X, each crosswise wire 6 being fixed to the lengthwise wires 5 on the interior volume 4 side.

Each crosswise wire 6 comprises, on the one hand, a base portion 6a belonging to the bottom 2 of the trunking 1 and, on the other hand, two lateral branches 6b arranged vertically in the example depicted and belonging to the lateral flanges 3 of the trunking 1.

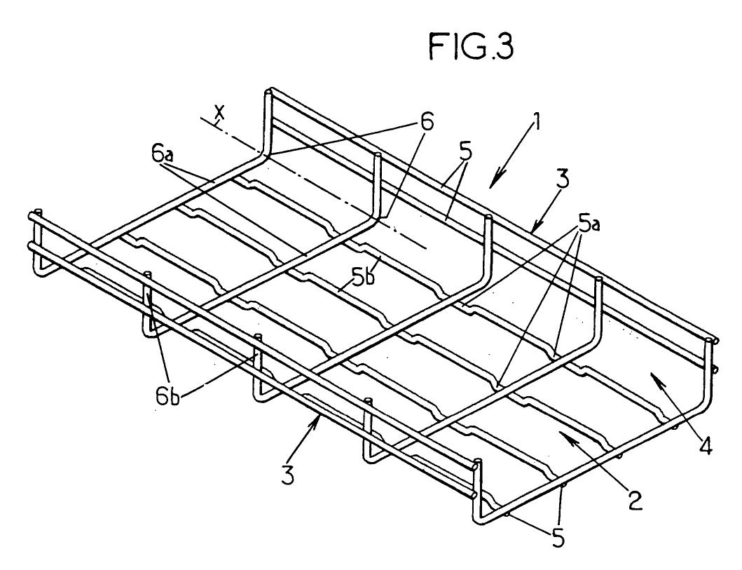

As can be seen in FIGS. 1 and 2, at least the lengthwise wires 5 belonging to the bottom 2 of the trunking each have a bend 5a where they intersect with the base portions 6a, the said bends Sa being connected by longitudinal portions 5b which, in the example depicted, are straight and parallel to the longitudinal direction X.

The bends 5a, which project away from the interior volume 4 of the trunking, are sized so that the base portions 6a of the crosswise wires are arranged at roughly the same level as the longitudinal portions 5b of the lengthwise wires.

More specifically, the bends 5a are sized so that the upper generatrix of the base portions 6a is aligned with the upper generatrix of the longitudinal portions 5b.

Thus, when a cable 7 or some other pipe or line is laid against the bottom 2 of the trunking 1, this cable 7 can rest perfectly flat without being locally deformed where it passes over the crosswise wires 6, even near a clamp 8 securing this cable 7 to one of the lengthwise wires 5.

As explained hereinabove, this approach avoids premature wear of the cable 7 or a loss in performance of this cable (particularly in the case of a cable used for transmitting data at a relatively high rate), and the use of the interior space 4 inside the trunking 1 is also optimized.

In addition, when the bottom 2 of the trunking rests on the ground or against another wall, the bends 5a leave a gap h corresponding to the thickness of a lengthwise wire 5 (for example 4 to 5 mm) under the longitudinal portions 5b of the lengthwise wires, and this then allows clamps 8 to be passed under the said longitudinal portions 5b under relatively easy conditions.

Finally, as depicted in FIG. 2, it is possible to have the trunking 1 supported by support members 9 such as yokes or the like, the lower horizontal branch 9a of which supports the lengthwise wires 5 belonging to the bottom 2, in the region of the longitudinal portions 5b of the lengthwise wires, that is to say between two crosswise wires 6.

Thus, the height H occupied by the trunking 1 above the lower branch 9a of the support member is reduced by the thickness of a crosswise wire (generally about 4 to 5 mm), for the same capacity.

The second embodiment of the invention, depicted in FIG. 3, is similar to the first embodiment described above, and will therefore not be described in detail.

Contrary to the first embodiment in which the bends 5a of the lengthwise wires had a width, in the direction X, corresponding roughly to the thickness of a crosswise wire 6 (in other words, just one crosswise wire 6 was housed in each bend 5a), the bends 5a in the second embodiment are wider in the direction X. Advantageously, the width of the said bends is greater than twice the thickness of a crosswise wire 6 and the said bends have a flat bottom, thus if necessary making it easier to assemble the crosswise wires 6 with the lengthwise wires 5 by increasing the acceptable manufacturing tolerances.

I claim:

1. Trunking running longitudinally in a first direction and comprising at least one substantially U-shaped section that has a bottom and two lateral flanges, said trunking delimiting an interior volume designed to accommodate pipes or lines running longitudinally in the first direction, said trunking comprising rigid lengthwise wires running substantially parallel to the first direction and rigid crosswise wires running substantially at right angles to the first direction, the crosswise wires being fixed to the lengthwise wires toward the interior volume of the trunking, and each crosswise wire comprising a base portion belonging to the bottom of the trunking and two lateral branches belonging respectively to each lateral flange of the trunking,
wherein at least the lengthwise wires belonging to the bottom of the trunking each comprise a succession of longitudinal portions connected by bends protruding away from the interior volume of the trunking, the bends of the lengthwise wires being designed to accommodate the base portions of the crosswise wires and being sized so that said base portions of the crosswise wires and the longitudinal portions of the lengthwise wires lie at substantially the same level.

2. Trunking according to claim 1, in which the longitudinal portions of the lengthwise wires are straight and parallel to the first direction.

3. Trunking according to claim 1, in which the base portions of the crosswise wires and the longitudinal portions of the lengthwise wires are arranged in substantially the same plane.

4. Trunking according to claim 1, in which the bends of the lengthwise wires each have a width, measured in the first direction, that substantially corresponds to the thickness of a crosswise wire.

5. Trunking according to claim 1, in which the bends of the lengthwise wires each have a width, measured in the first direction, that is greater than twice the thickness of a crosswise wire.

6. Trunking according to claim 5, in which the bends in the lengthwise wires each have a flat bottom.
